(19) United States
(12) Patent Application Publication
(10) Pub. No.: US 2024/0106144 A1
(43) Pub. Date: Mar. 28, 2024

(54) CONNECTION DEVICE

(71) Applicant: YOKOWO CO., LTD., Chiyoda-ku, Tokyo (JP)

(72) Inventors: Takahiro NAKAMURA, Iruma-gun, Saitama (JP); Yasushi SHIRAKATA, Kita-ku, Tokyo (JP); Shoichi KOSHIKAWA, Kita-ku, Tokyo (JP)

(73) Assignee: YOKOWO CO., LTD., Chiyoda-ku, Tokyo (JP)

(21) Appl. No.: 18/276,456

(22) PCT Filed: Feb. 3, 2022
(86) PCT No.: PCT/JP2022/004246

§ 371 Date: Aug. 9, 2023

(30) Foreign Application Priority Data
Feb. 17, 2021 (JP) 2021-023183

(51) Int. Cl. H01R 12/77; H01R 9/05; H01R 24/50

(52) U.S. Cl. CPC H01R 12/771; H01R 9/0515; H01R 24/50

(57) ABSTRACT

A connection device (10) includes a flexible substrate (200), a coaxial connector (300) overlapping with the flexible substrate (200), and a jig (400) fixing the flexible substrate (200) and the coaxial connector (300).

### TECHNICAL FIELD

The present invention relates to a connection device.

### BACKGROUND ART

In recent years, as described in Patent Document 1 or 2, for example, various connection devices including a coaxial connector and a flexible substrate electrically connected to the coaxial connector have been developed. In Patent Document 1, a coaxial connector and a flexible substrate are electrically connected to each other through a hole provided in a probe card located between the coaxial connector and the flexible substrate. In Patent Document 2, a coaxial connector and a flexible substrate are electrically connected to each other through a hole provided in a connection printed board located between the coaxial connector and the flexible substrate.

### RELATED DOCUMENT

### Patent Document

Patent Document 1: Japanese Patent Application Publication No. 2008-82734
Patent Document 2: Japanese Patent Application Publication No. H2-237131

### SUMMARY OF INVENTION

### Technical Problem

For example, as described in Patent Document 1 or 2, to electrically connect a coaxial connector to a flexible substrate, the coaxial connector may be fixed to the flexible substrate by solder. The use of solder, however, may cause instability in an electrical characteristic of connection between the coaxial connector and the flexible substrate due to various factors such as a variation in performance by handwork of soldering, deformation of the flexible substrate due to heat of a soldering iron, and formation of a stub of solder.

One example of an object of the present invention is to stabilize an electrical characteristic of connection between a coaxial connector and a flexible substrate. Another object of the present invention will become apparent from the description of the present specification.

### Solution to Problem

An aspect of the present invention is a connection device including:
a flexible substrate;
a coaxial connector overlapping with the flexible substrate; and
a jig fixing the flexible substrate and the coaxial connector.

### Advantageous Effects of Invention

According to the aspect described above of the present invention, an electrical characteristic of connection between a coaxial connector and a flexible substrate can be stabilized.

### BRIEF DESCRIPTION OF DRAWINGS

FIG. 1 A perspective view of a connection device according to an embodiment.

FIG. 2 A perspective view with a rigid substrate being removed from FIG. 1.

FIG. 3 A perspective view of the connection device illustrated in FIG. 2 as viewed from a side on which coaxial connectors are located.

FIG. 4 A cross-sectional view taken along an A-A′ line in FIG. 1.

FIG. 5 A cross-sectional view of a connection device according to a variant.

### DESCRIPTION OF EMBODIMENTS

Hereinafter, embodiments and the variants of the present invention will be described by using drawings. In all of the drawings, a similar component has a similar reference sign, and description thereof will be appropriately omitted.

In the present specification, an ordinal numeral such as “first”, “second”, and “third” is provided for simply distinguishing a configuration provided with a similar name unless otherwise specified, and does not indicate a specific characteristic (for example, an order or importance) of a configuration.

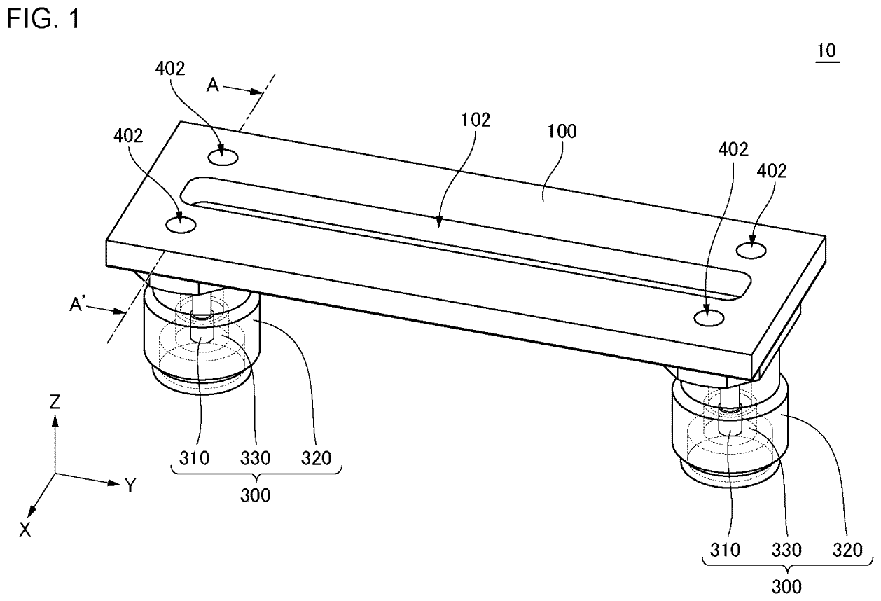

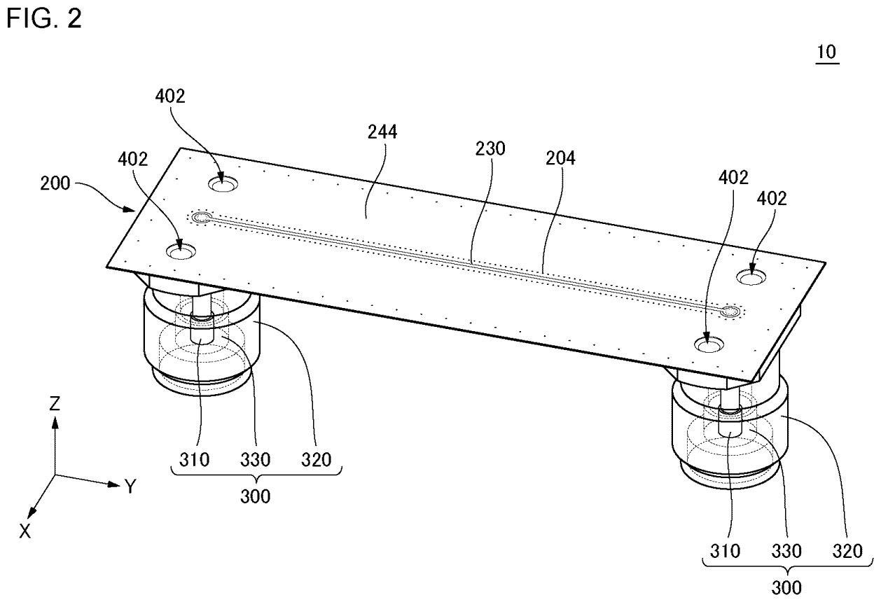

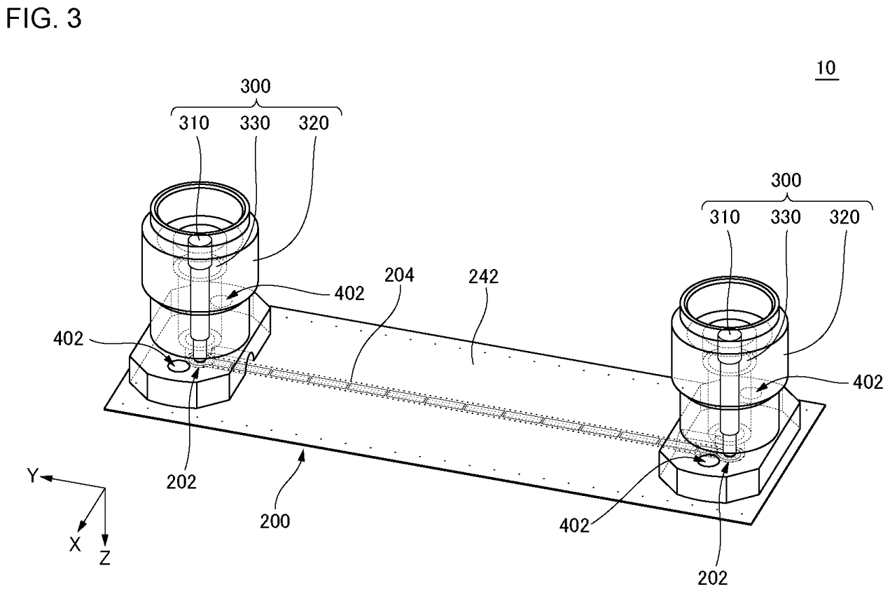

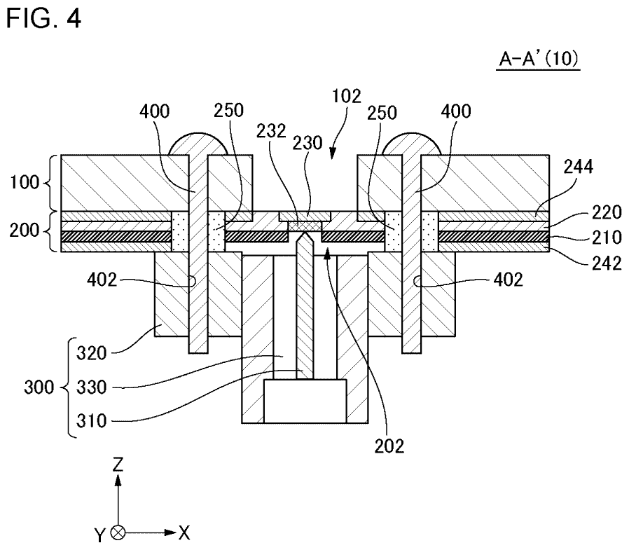

FIG. 1 is a perspective view of a connection device 10 according to an embodiment. FIG. 2 is a perspective view with a rigid substrate 100 being removed from FIG. 1. FIG. 3 is a perspective view of the connection device 10 illustrated in FIG. 2 as viewed from a side on which coaxial connectors 300 are located. FIG. 4 is a cross-sectional view taken along an A-A′ line in FIG. 1. FIGS. 1 to 3 do not illustrate a jig 400 illustrated in FIG. 4.

In FIGS. 1 to 4, an arrow indicating a first direction X, a second direction Y, or a third direction Z indicates that a direction from a base end to a tip end of the arrow is a positive direction of the direction indicated by the arrow, and a direction from the tip end to the base end of the arrow is a negative direction of the direction indicated by the arrow. In FIG. 4, a white circle with an X indicating the second direction Y indicates that a direction from the front to the back of the paper plane is a positive direction of the direction indicated by the white circle with the X, and a direction from the back to the front of the paper plane is a negative direction of the direction indicated by the white circle with the X. The same applies to subsequent drawings in FIGS. 1 to 4.

In FIGS. 1 to 4, the first direction X is a direction parallel to one direction orthogonal to a height direction of the connection device 10. Specifically, the first direction X is a direction parallel to a short direction of the connection device 10. A positive direction of the first direction X is a direction parallel to a direction from one side to another side of the short direction of the connection device 10. A negative direction of the first direction X is a direction opposite to the positive direction of the first direction X. The second direction Y is a direction parallel to a direction orthogonal to both of the height direction of the connection device 10 and the first direction X. Specifically, the second direction Y is a direction parallel to a long direction of the connection device 10. A positive direction of the second direction Y is a direction parallel to a direction from one side to another side of the long direction of the connection device 10. A negative direction of the second direction Y is a direction opposite to the positive direction of the second direction Y. The third direction Z is a direction parallel to the height direction of the connection device 10. The third direction Z is also a direction parallel to a thickness direction of the rigid substrate 100 described below and a thickness direction of a flexible substrate 200 described below. A positive direction of the third direction Z is a direction parallel to a direction from the coaxial connector 300 described below is located to a side on which the rigid substrate 100 is located. A negative direction of the third direction Z is a direction parallel to a direction from the side on which the rigid substrate 100 is located to the side on which the coaxial connector 300 is located.

Hereinafter, the positive direction of the third direction Z is described as an upward direction of a vertical direction (height direction of the connection device 10) and the negative direction of the third direction Z is described as a downward direction of the vertical direction. A relationship among the first direction X, the second direction Y, the third direction Z, and the vertical direction is not limited to the description below. For example, the first direction X or the second direction Y may be parallel to the vertical direction. The positive direction of the third direction Z may be a downward direction of the vertical direction and the negative direction of the third direction Z may be an upward direction of the vertical direction.

First, the rigid substrate 100, the flexible substrate 200, and two coaxial connectors 300 will be described with reference to FIGS. 1 to 4.

The connection device 10 includes the rigid substrate 100, the flexible substrate 200, and the two coaxial connectors 300. The flexible substrate 200 includes a base layer 210, an adhesive layer 220, a signal conductive layer 230, a connection conductive layer 232, a lower ground conductive layer 242, an upper ground conductive layer 244, and a spacer 250. Each of the coaxial connectors 300 includes a terminal 310, a conductive body 320, and an insulator 330.

The rigid substrate 100 is, for example, a printed circuit board (PCB) such as a flame retardant type 4 (FR4). As illustrated in FIG. 1, when viewed from the third direction Z, the rigid substrate 100 is a rectangle having a pair of short sides parallel to the first direction X and a pair of long sides parallel to the second direction Y. A shape of the rigid substrate 100 when viewed from the third direction Z may be a shape different from a rectangle such as a quadrilateral other than a rectangle.

As illustrated in FIGS. 1 and 4, in the rigid substrate 100, an air gap 102 is defined by a through hole penetrating through the rigid substrate 100 in the third direction Z. At least a part of the air gap 102 overlaps with the signal conductive layer 230 in the third direction Z. In other words, the rigid substrate 100 is provided with a region, such as the air gap 102 for example, at least partially overlapping with the signal conductive layer 230 in the third direction Z. The region has a dielectric constant lower than a dielectric constant around the region of the rigid substrate 100 in a direction perpendicular to the third direction Z. The signal conductive layer 230 functions as a transmission line. Hereinafter, the above-described region provided in the rigid substrate 100 is referred to as a dielectric constant adjustment region as necessary. At least a part of a surface of the signal conductive layer 230 on a positive direction side of the third direction Z is in contact with at least a part of the air gap 102. In this case, a dielectric loss of a transmission loss of the signal conductive layer 230 can be reduced as compared to a case where a dielectric constant of the dielectric constant adjustment region is equal to or more than a dielectric constant around the dielectric constant adjustment region of the rigid substrate 100 in the direction perpendicular to the third direction Z. A material having a dielectric constant lower than a dielectric constant of a material constituting the rigid substrate 100 may be provided in the region provided with the air gap 102. Alternatively, a dielectric constant of the dielectric constant adjustment region may be equal to or more than a dielectric constant around the dielectric constant adjustment region of the rigid substrate 100 in the direction perpendicular to the third direction Z.

A structure in which a dielectric constant of the dielectric constant adjustment region is lower than a dielectric constant around the dielectric constant adjustment region of the rigid substrate 100 in the direction perpendicular to the third direction Z is not limited to the structure according to the present embodiment. For example, a plurality of through holes penetrating through the rigid substrate 100 in the third direction Z may be provided in the dielectric constant adjustment region. In this case, the strength of the rigid substrate 100 can be increased as compared to a case where a single through hole penetrating through the rigid substrate 100 in the third direction Z is provided across the entire dielectric constant adjustment region. A recessed portion not penetrating through the rigid substrate 100 in the third direction Z may be provided in a surface of the rigid substrate 100 in the dielectric constant adjustment region on a negative direction side of the third direction Z. In this case, the strength of the rigid substrate 100 can be increased as compared to the case where a single through hole penetrating through the rigid substrate 100 in the third direction Z is provided across the entire dielectric constant adjustment region.

The flexible substrate 200 is, for example, a flexible printed circuit (FPC). As illustrated in FIGS. 2 and 3, when viewed from the third direction Z, the flexible substrate 200 is a rectangle having a pair of short sides parallel to the first direction X and a pair of long sides parallel to the second direction Y. A shape of the flexible substrate 200 when viewed from the third direction Z may be a shape different from a rectangle such as a quadrilateral other than a rectangle.

The base layer 210 contains a resin such as polyimide, for example.

As illustrated in FIG. 4, the adhesive layer 220 is located on the positive direction side of the third direction Z with respect to the base layer 210.

As illustrated in FIG. 4, the signal conductive layer 230 is located on the positive direction side of the third direction Z with respect to the base layer 210. The signal conductive layer 230 adheres to a surface of the base layer 210 on the positive direction side of the third direction Z by the adhesive layer 220. A part of the adhesive layer 220 is located between the signal conductive layer 230 and the upper ground conductive layer 244 in the direction perpendicular to the third direction Z. An edge of the signal conductive layer 230 on a direction side perpendicular to the third direction Z is held by the part of the adhesive layer 220 located between the signal conductive layer 230 and the upper ground conductive layer 244 in the direction perpendicular to the third direction Z. As illustrated in FIG. 2, the signal conductive layer 230 extends in the second direction Y. Both ends of the signal conductive layer 230 in the second direction Y have a circular shape having a diameter greater than a width in the first direction X of a linear portion of the signal conductive layer 230 located between the both ends. A shape of the signal conductive layer 230 is not limited to this example.

As illustrated in FIG. 4, the lower ground conductive layer 242 is located on the negative direction side of the third direction Z with respect to the base layer 210. As illustrated in FIG. 3, two through holes 202 are provided in a region of the lower ground conductive layer 242 overlapping, in the third direction Z, with the both ends of the signal conductive layer 230 in the second direction Y. Hereinafter, the through hole 202 of the two through holes 202 located on a positive direction side of the second direction Y is referred to as the through hole 202 on the positive direction side of the second direction Y as necessary. The through hole 202 of the two through holes 202 located on a negative direction side of the second direction Y is referred to as the through hole 202 on the negative direction side of the second direction Y as necessary.

As illustrated in FIG. 4, the upper ground conductive layer 244 is located on the positive direction side of the third direction Z with respect to the base layer 210. The upper ground conductive layer 244 adheres to the surface of the base layer 210 on the positive direction side of the third direction Z by the adhesive layer 220. At least a part of the upper ground conductive layer 244 overlaps with at least a part of the lower ground conductive layer 242 in the third direction Z. As illustrated in FIG. 2, the upper ground conductive layer 244 surrounds a side surface of the signal conductive layer 230 facing in the direction perpendicular to the third direction Z.

As illustrated in FIGS. 2 and 3, when viewed from the third direction Z, a plurality of vias 204 are provided in the flexible substrate 200 to surround the signal conductive layer 230. The plurality of vias 204 may not be provided.

Each of the coaxial connectors 300 is, for example, a subminiature version A (SMA) connector. As illustrated in FIGS. 1 to 3, the two coaxial connectors 300 are aligned in the second direction Y. Hereinafter, the coaxial connector 300 of the two coaxial connectors 300 located on the positive direction side of the second direction Y is referred to as the coaxial connector 300 on the positive direction side of the second direction Y as necessary. The coaxial connector 300 of the two coaxial connectors 300 located on the negative direction side of the second direction Y is referred to as the coaxial connector 300 on the negative direction side of the second direction Y as necessary.

The terminal 310 has a pin shape extending in the third direction Z. The terminal 310 is biased toward the positive direction of the third direction Z by an elastic body such as a spring. One end of the terminal 310 on the positive direction side of the third direction Z of the coaxial connector 300 on the positive direction side of the second direction Y is electrically connected to one end of the signal conductive layer 230 on the positive direction side of the second direction Y. One end of the terminal 310 on the positive direction side of the third direction Z of the coaxial connector 300 on the negative direction side of the second direction Y is electrically connected to the other end of the signal conductive layer 230 on the negative direction side of the second direction Y.

The conductive body 320 contains, for example, a metal. The conductive body 320 surrounds an outer surface of the terminal 310 facing in the direction perpendicular to the third direction Z. A surface of the conductive body 320 on the positive direction side of the third direction Z of the coaxial connector 300 on the positive direction side of the second direction Y is electrically connected to a periphery of the lower ground conductive layer 242 in the direction perpendicular to the third direction Z of the through hole 202 on the positive direction side of the second direction Y. A surface of the conductive body 320 on the positive direction side of the third direction Z of the coaxial connector 300 on the negative direction side of the second direction Y is electrically connected to a periphery of the lower ground conductive layer 242 in the direction perpendicular to the third direction Z of the through hole 202 on the negative direction side of the second direction Y.

The insulator 330 is located between the outer surface of the terminal 310 facing in the direction perpendicular to the third direction Z, and an inner surface of the conductive body 320 facing the outer surface of the terminal 310.

As illustrated in FIG. 4, the rigid substrate 100, the flexible substrate 200, and the coaxial connector 300 overlap with one another in the third direction Z. The rigid substrate 100 is located on a side opposite to a side of the flexible substrate 200 on which the coaxial connector 300 is located. In this case, a non-illustrated conductor of the rigid substrate 100 provided on the negative direction side of the third direction Z and a non-illustrated conductor of the flexible substrate 200 provided on the positive direction side of the third direction Z can be electrically connected to each other.

Next, the jig 400 will be described with reference to FIGS. 1 to 4.

The connection device 10 includes four jigs 400 provided in four communication holes 402 illustrated in FIGS. 1 to 3. Two jigs 400 provided in two communication holes 402 of the four communication holes 402 located on the positive direction side of the second direction Y are provided in the coaxial connector 300 on the positive direction side of the second direction Y. The two jigs 400 are provided on both sides in the first direction X with respect to the through hole 202 on the positive direction side of the second direction Y. Two jigs 400 provided in two communication holes 402 of the four communication holes 402 located on the negative direction side of the second direction Y are on the other hand provided in the coaxial connector 300 on the negative direction side of the second direction Y. The two jigs 400 are provided on both sides in the first direction X with respect to the through hole 202 on the negative direction side of the second direction Y. A position in which the jig 400 is provided is not limited to the example according to the present embodiment.

The following description of the jig 400 relates to any of the four jigs 400 described above unless otherwise specified.

The jig 400 is a screw such as a vis and a bolt. The jig 400 extends in the third direction Z. A head of the screw of the jig 400 is not necessary. As illustrated in FIG. 4, at least a part of the jig 400 is inserted through the communication hole 402 communicating with the rigid substrate 100, the flexible substrate 200, and the coaxial connector 300 in the third direction Z. Furthermore, at least a part of the jig 400 is tightened such that a compressive force in the third direction Z is applied to the rigid substrate 100, the flexible substrate 200, and the coaxial connector 300.

Specifically, as illustrated in FIG. 4, the jig 400 located on the positive direction side of the first direction X with respect to the through hole 202 is inserted in the third direction Z from the positive direction side of the third direction Z through the communication hole 402 of the rigid substrate 100, the flexible substrate 200, and a portion of the conductive body 320 located on the positive direction side of the first direction X of the terminal 310. An inner surface of the communication hole 402 of the portion of the conductive body 320 located on the positive direction side of the first direction X of the terminal 310 is provided with a screw thread or a screw groove that engages with a screw thread or a screw groove provided on an outer surface of the jig 400 located on the positive direction side of the first direction X with respect to the through hole 202. The jig 400 located on the positive direction side of the first direction X with respect to the through hole 202 is accordingly tightened by engaging the screw thread or the screw groove provided on the outer surface of the jig 400 located on the positive direction side of the first direction X with respect to the through hole 202 with the screw thread or the screw groove provided on the inner surface of the communication hole 402 of the portion of the conductive body 320 located on the positive direction side of the first direction X of the terminal 310. The jig 400 located on the negative direction side of the first direction X with respect to the through hole 202 is on the other hand inserted in the third direction Z from the positive direction side of the third direction Z through the communication hole 402 of the rigid substrate 100, the flexible substrate 200, and a portion of the conductive body 320 located on the negative direction side of the first direction X of the terminal 310. An inner surface of the communication hole 402 of the portion of the conductive body 320 located on the negative direction side of the first direction X of the terminal 310 is provided with a screw thread or a screw groove that engages with a screw thread or a screw groove provided on an outer surface of the jig 400 located on the negative direction side of the first direction X with respect to the through hole 202. The jig 400 located on the negative direction side of the first direction X with respect to the through hole 202 is accordingly tightened by engaging the screw thread or the screw groove provided on the outer surface of the jig 400 located on the negative direction side of the first direction X with respect to the through hole 202 with the screw thread or the screw groove provided on the inner surface of the communication hole 402 of the portion of the conductive body 320 located on the negative direction side of the first direction X of the terminal 310.

Tightening of at least a part of the jig 400 (a portion of the jig 400 having a width greater than a width of the communication hole 402 in the first direction X or the second direction Y) causes the jig 400 to fix the rigid substrate 100, the flexible substrate 200, and the coaxial connector 300 in the third direction Z. The use of the jig 400 to fix the coaxial connector 300 to the flexible substrate 200 eliminates necessity of use of solder to fix the coaxial connector 300 to the flexible substrate 200. The use of solder may cause instability in an electrical characteristic of connection between the coaxial connector 300 and the flexible substrate 200 due to various factors such as a variation in performance by handwork of soldering, deformation of the flexible substrate 200 due to heat of a soldering iron, and formation of a stub of solder. In contrast, these factors can be suppressed in the present embodiment. The electrical characteristic of connection between the coaxial connector 300 and the flexible substrate 200 can be thus stabilized in the present embodiment as compared to a case where solder is used. Furthermore, soldering in connection between the coaxial connector 300 and the flexible substrate 200 is unnecessary in the present embodiment. Time required for the soldering may be relatively long. Thus, time required for manufacturing of the connection device 10 may be shorter in the present embodiment than the case where solder is used.

In the present embodiment, insertion of at least a part of the jig 400 through the communication hole 402 causes alignment of the rigid substrate 100, the flexible substrate 200, and the coaxial connector 300 in the direction perpendicular to the third direction Z. Thus, the rigid substrate 100, the flexible substrate 200, and the coaxial connector 300 can be easily fixed in the direction perpendicular to the third direction Z as compared to a case where the jig 400 is a jig such as a clamp that clamps the rigid substrate 100, the flexible substrate 200, and the coaxial connector 300 in the third direction Z and compresses the rigid substrate 100, the flexible substrate 200, and the coaxial connector 300 in the third direction Z without being inserted through the communication hole 402.

A method of fixing the rigid substrate 100, the flexible substrate 200, and the coaxial connector 300 in the third direction Z is not limited to the example according to the present embodiment. For example, at least a part of the jig 400 may be press-fitted into at least a part of the communication hole 402. In this case, the jig 400 may be inserted through the communication hole 402 of the rigid substrate 100 and the flexible substrate 200 from the positive direction side of the third direction Z, and press-fitted into the communication hole 402 of the conductive body 320. The jig 400 may be inserted through the communication hole 402 of the conductive body 320 and the flexible substrate 200 from the negative direction side of the third direction Z, and press-fitted into the communication hole 402 of the rigid substrate 100. Alternatively, the jig 400 may not be provided in the communication hole 402. In this case, the jig 400 may be a jig such as a clamp that clamp the rigid substrate 100, the flexible substrate 200, and the coaxial connector 300 in the third direction Z and compresses the rigid substrate 100, the flexible substrate 200, and the coaxial connector 300 in the third direction Z.

Next, the spacer 250 will be described in detail with reference to FIG. 4.

In an example illustrated in FIG. 4, two spacers 250 are provided on both sides in the first direction X with respect to the through hole 202. At least a part of each of the spacers 250 is located inside the flexible substrate 200. Each of the spacers 250 has a hollow structure that defines the communication hole 402 to insert the jig 400 in the third direction Z. Specifically, the jig 400 located on the positive direction side of the first direction X with respect to the through hole 202 is inserted through the communication hole 402 of the spacer 205 located on the positive direction side of the first direction X with respect to the through hole 202. The jig 400 located on the negative direction side of the first direction X with respect to the through hole 202 is inserted through the communication hole 402 of the spacer 250 located on the negative direction side of the first direction X with respect to the through hole 202.

The following description of the spacer 250 relates to any of the two spacers 250 described above unless otherwise specified.

Rigidity of the spacer 250 is higher than rigidity of the flexible substrate 200. For example, the spacer 250 has rigidity that rarely becomes deformed or does not become deformed at all by a compressive force of the jig 400 in the third direction Z. Accordingly, a collapse of the flexible substrate 200 due to a compressive force of the jig 400 in the third direction Z can be suppressed according to the present embodiment as compared to a case where the spacer 250 is not provided.

A compressive force applied from the jig 400 to the flexible substrate 200 in the third direction Z may be locally greater in a portion of the flexible substrate 200 through which the jig 400 is inserted in the third direction Z than a periphery in the direction perpendicular to the third direction Z of the portion of the flexible substrate 200 through which the jig 400 is inserted in the third direction Z. Accordingly, a collapse of the portion of the flexible substrate 200 through which the jig 400 is inserted in the third direction Z due to a compressive force of the jig 400 in the third direction Z can be suppressed according to the present embodiment as compared to a case where the jig 400 is not inserted through the spacer 250 in the third direction Z and the spacer 250 is provided offset with the jig 400 in the direction perpendicular to the third direction Z.

The spacer 250 is a conductor such as a metal. The spacer 250 is inserted through the base layer 210, the adhesive layer 220, the lower ground conductive layer 242, and the upper ground conductive layer 244 in the third direction Z. The lower ground conductive layer 242 and the upper ground conductive layer 244 can be accordingly electrically connected to each other via the spacer 250. When the rigid substrate 100, the flexible substrate 200, and the coaxial connector 300 are fixed by the jig 400, the surface of the conductive body 320 on the positive direction side of the third direction Z can be in contact with a surface of the spacer 250 on the negative direction side of the third direction Z and a surface of the lower ground conductive layer 242 on the negative direction side of the third direction Z. Thus, the conductive body 320 can be electrically connected to the spacer 250 and the lower ground conductive layer 242.

An arrangement and a structure of the spacer 250 are not limited to the example according to the present embodiment. For example, the spacer 250 may not be provided. The spacer 250 may be provided offset with the jig 400 in the direction perpendicular to the third direction Z such that the jig 400 is not inserted through the spacer 250 in the third direction Z. Furthermore, the spacer 250 may be an insulator.

Next, electrical connection between the terminal 310 and the signal conductive layer 230 will be described in detail with reference to FIG. 4.

At least a part of the coaxial connector 300, specifically, at least a part of the terminal 310 is inserted through the through hole 202 in the third direction Z. One end of the terminal 310 on the positive direction side of the third direction Z is electrically connected to the signal conductive layer 230 via the connection conductive layer 232. The connection conductive layer 232 is located between the one end of the terminal 310 on the positive direction side of the third direction Z and a surface of the signal conductive layer 230 on the negative direction side of the third direction Z.

In the present embodiment, the one end of the terminal 310 on the positive direction side of the third direction Z can be pushed against the surface of the signal conductive layer 230 on the negative direction side of the third direction Z via the connection conductive layer 232. This eliminates necessity use of solder for electrical connection between the terminal 310 and the signal conductive layer 230. The electrical characteristic of connection between the terminal 310 and the signal conductive layer 230 can accordingly stabilized as described above as compared to the case where solder is used.

In the present embodiment, there is no necessity to electrically connect the terminal 310 and the signal conductive layer 230 to each other through a via provided inside the base layer 210 and the adhesive layer 220. In use of the via, the via may become a parasitic inductance or a resistance and affect an electrical length of a transmission line including the signal conductive layer 230. In contrast, the influence of the via on the electrical length of the transmission line can be suppressed when not using the via.

Furthermore, in the present embodiment, a force biasing the terminal 310 to the side on which the signal conductive layer 230 is located can be increased as compared to a case where the one end of the terminal 310 on the positive direction side of the third direction Z is directly pushed against the signal conductive layer 230 on the negative direction side of the third direction Z without through the connection conductive layer 230. Accordingly, the electrical connection between the terminal 310 and the signal conductive layer 230 can be more reliable than when the connection conductive layer 232 is not provided. The influence of the parasitic inductance or the resistance of the connection conductive layer 232 on the electrical length of the transmission line including the signal conductive layer 230 can be reduced by appropriately adjusting a thickness of the connection conductive layer 232 in the third direction Z and a width of the connection conductive layer 232 in the direction perpendicular to the third direction Z.

The electrical connection between the terminal 310 and the signal conductive layer 230 can also be applied to a case where the terminal 310 is electrically connected to a conductor different from the signal conductive layer 230. In other words, at least a part of the coaxial connector 300 such as the terminal 310 can be inserted through a hole such as the through hole 202 provided in a second conductor such as the lower ground conductive layer 242, and can be electrically connected to a first conductor such as the signal conductive layer 230. A third conductor such as the connection conductive layer 232 may be located between at least a part of the coaxial connector 300 such as the terminal 310 and the first conductor such as the signal conductive layer 230. At least a part of the coaxial connector 300 such as the terminal 310 may be directly pushed against the first conductor such as the signal conductive layer 230 without through the third conductor such as the connection conductive layer 232. Furthermore, the terminal 310 may be electrically connected to the signal conductive layer 230 through a via provided inside the flexible substrate 200.

In the example illustrated in FIG. 4, a width of the through hole 202 in the first direction X is greater than a width of the signal conductive layer 230 in the first direction X. In this case, a decrease in characteristic of the signal conductive layer 230 due to a distance being too small between the signal conductive layer 230 and portions of the lower ground conductive layer 242 on both sides of the through hole 202 in the first direction X can be suppressed as compared to a case where a width of the through hole 202 in the first direction X is equal to or less than a width of the signal conductive layer 230 in the first direction X.

Next, one example of a method of manufacturing the connection device 10 will be described.

First, the rigid substrate 100, the flexible substrate 200, and the coaxial connectors 300 are prepared. The flexible substrate 200 is manufactured as follows, for example.

First, the base layer 210 is prepared.

Next, the lower ground conductive layer 242 is formed on the negative direction side of the third direction Z of the base layer 210. In one example, the lower ground conductive layer 242 is formed by patterning a conductor such as a metal by photolithography. In this example, the lower ground conductive layer 242 is formed such that the through hole 202 is provided in the lower ground conductive layer 242.

Next, the signal conductive layer 230 and the upper ground conductive layer 244 are formed on the positive direction side of the third direction Z of the base layer 210 through the adhesive layer 220. In this case, embedding of the signal conductive layer 230 and the upper ground conductive layer 244 in the adhesive layer 220 toward the negative direction of the third direction Z allows a part of the adhesive layer 220 to be located between the signal conductive layer 230 and the upper ground conductive layer 244 in the direction perpendicular to the third direction Z. In one example, the signal conductive layer 230 and the upper ground conductive layer 244 are formed by applying a metal foil such as a copper foil to be the signal conductive layer 230 and the upper ground conductive layer 244 to the positive direction side of the third direction Z of the base layer 210 through the adhesive layer 220.

Next, the through hole 202 is formed in the base layer 210 and the adhesive layer 220. At least a part of the surface of the signal conductive layer 230 on the negative direction side of the third direction Z is exposed from the through hole 202.

Next, a through hole for forming the spacer 250 is formed in the base layer 210, the adhesive layer 220, the signal conductive layer 230, the lower ground conductive layer 242, and the upper ground conductive layer 244. Next, a conductor such as a metal to be the spacer 250 is embedded inside the through hole. Next, the communication hole 402 is formed in the conductor.

Next, the connection conductive layer 232 is formed inside the through hole 202 and on the negative direction side of the third direction Z of the signal conductive layer 230. In one example, the connection conductive layer 232 is formed by plating.

Thus, the flexible substrate 200 is manufactured.

Next, the flexible substrate 200 is disposed between the rigid substrate 100 and the coaxial connector 300. Next, the jig 400 is inserted through the communication hole 402 of the rigid substrate 100, the flexible substrate 200, and the conductive body 320 from the positive direction side of the third direction Z. Furthermore, the jig 400 is tightened by engaging the screw thread or the screw groove provided on the outer surface of the jig 400 with the screw thread or the screw groove provided on the inner surface of the communication hole 402 of the conductive body 320.

Thus, the connection device 10 is manufactured.

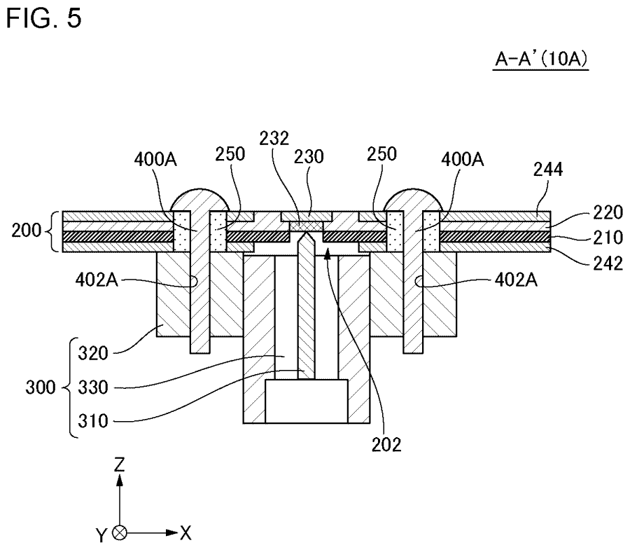

FIG. 5 is a cross-sectional view of a connection device 10A according to a variant. The connection device 10A according to the variant is similar to the communication device 10 according to the embodiment except for the following points.

The connection device 10A does not include the rigid substrate 100 illustrated in FIG. 4. At least a part of a jig 400A is inserted through a communication hole 402A provided in a flexible substrate 200 and a coaxial connector 300. Specifically, the jig 400A is inserted through the communication hole 402A of the flexible substrate 200 from the positive direction side of the third direction Z. At least a part of the jig 400A is tightened such that a compressive force in the third direction Z is applied to the flexible substrate 200 and the coaxial connector 300. Thus, the jig 400A fixes the flexible substrate 200 and the coaxial connector 300 in the third direction Z and the direction perpendicular to the third direction Z. Furthermore, similarly to the embodiment, one end of a terminal 310 on the positive direction side of the third direction Z is electrically connected to a signal conductive layer 230 through a connection conductive layer 232.

Also in the present variant, similarly to the embodiment, an electrical characteristic of connection between the coaxial connector 300 and the flexible substrate 200 can be stabilized.

While the embodiments and the variants of the present invention have been described with reference to the drawings, the embodiments and the variants are only exemplification of the present invention, and various configurations other than the above-described embodiments and variants may also be employed.

According to the present specification, the following aspects are provided.

(Aspect 1)

An aspect 1 is a connection device including:
a flexible substrate;
a coaxial connector overlapping with the flexible substrate; and
a jig fixing the flexible substrate and the coaxial connector.

According to the aspect 1, the use of the jig to fix the coaxial connector to the flexible substrate eliminates necessity of use of solder to fix the coaxial connector to the flexible substrate. The use of solder may case instability in an electrical characteristic of connection between the coaxial connector and the flexible substrate due to various factors such as a variation in performance by handwork of soldering, deformation of the flexible substrate due to heat of a soldering iron, and formation of a stub of solder. In contrast, these factors can be suppressed in the aspect 1. Thus, in the aspect 1, an electrical characteristic of connection between the coaxial connector and the flexible substrate can be stabilized as compared to a case where solder is used.

(Aspect 2)

An aspect 2 is the connection device according to the aspect 1, wherein
at least a part of the jig is inserted through a communication hole communicating with the flexible substrate and the coaxial connector.

According to the aspect 2, inserting of at least a part of the jig through the communication hole causes alignment of the flexible substrate and the coaxial connector in a direction perpendicular to a thickness direction of the flexible substrate. Thus, the flexible substrate and the coaxial connector can be easily fixed in the direction perpendicular to the thickness direction of the flexible substrate as compared to a case where the jig is a jig such as a clamp that clamps the flexible substrate and the coaxial connector in the thickness direction of the flexible substrate and compresses the flexible substrate and the coaxial connector in the thickness direction of the flexible substrate without being inserted through the communication hole.

(Aspect 3)

An aspect 3 is the connection device according to the aspect 1 or 2, further including
a rigid substrate located on a side of the flexible substrate opposite to a side on which the coaxial connector is located, wherein
the jig fixes the rigid substrate together with the flexible substrate and the coaxial connector.

According to the aspect 3, a conductor of the rigid substrate provided on a side on which the flexible substrate is located and a conductor of the flexible substrate provided on a side on which the rigid substrate is located can be electrically connected to each other.

(Aspect 4)

An aspect 4 is the connection device according to the aspect 3, wherein
the flexible substrate includes a transmission line,
the rigid substrate is provided with a region at least partially overlapping with the transmission line, and
the region has a dielectric constant lower than a dielectric constant of the rigid substrate around the region.

According to the aspect 4, a dielectric loss of a transmission loss of the transmission line can be reduced as compared to a case where a dielectric constant of the region provided on the rigid substrate is equal to or more than a dielectric constant around the region of the rigid substrate.

### (Aspect 5)

An aspect 5 is the connection device according to any one of the aspects 1 to 4, wherein
the flexible substrate includes a first conductor and a second conductor, and
at least a part of the coaxial connector is inserted through a hole provided in the second conductor, and electrically connected to the first conductor.

According to the aspect 5, there is no necessity to electrically connect the coaxial connector and the first conductor to each other through a via provided inside the flexible substrate. In use of the via, the via may become a parasitic inductance or a resistance, and affect an electrical length of a transmission line including the first conductor. In contrast, the influence of the via on the electrical length of the transmission line can be suppressed when not using the via.

### (Aspect 6)

An aspect 6 is the connection device according to the aspect 5, further including
a third conductor located between the first conductor and the at least a part of the coaxial connector.

According to the aspect 6, a force biasing at least a part of the coaxial connector to a side on which the first conductor is located can be increased as compared to a case where at least a part of the coaxial connector is directly pushed against the first conductor without through the third conductor. Accordingly, the electrical connection between at least a part of the coaxial connector and the first conductor can be made more reliable than when the third conductor is not provided.

(Aspect 7)

An aspect 7 is the connection device according to any one of the aspects 1 to 6, further including
a spacer at least partially located inside the flexible substrate.

According to the aspect 7, a collapse of the flexible substrate due to a compressive force of the jig can be suppressed as compared to a case where the spacer is not provided.

(Aspect 8)

An aspect 8 is the connection device according to the aspect 7, wherein
the jig is inserted through the spacer.

According to the aspect 8, a collapse of a portion of the flexible substrate through which the jig is inserted due to a compressive force of the jig can be suppressed as compared to a case where the jig does not penetrate through the spacer and the spacer is provided offset with the jig.

This application claims priority based on Japanese patent application No. 2021-023183, filed on Feb. 17, 2021, the disclosure of which is incorporated herein in its entirety by reference.

### REFERENCE SIGNS LIST

10 Connection device
10A Connection device
100 Rigid substrate
102 Air gap
200 Flexible substrate
202 Through hole
204 Via
210 Base layer
220 Adhesive layer
230 Signal conductive layer
232 Connection conductive layer
242 Lower ground conductive layer
244 Upper ground conductive layer
250 Spacer
300 Coaxial connector
310 Terminal
320 Conductive body
330 Insulator
400 Jig
400A Jig
402 Communication hole
402A Communication hole
X First direction
Y Second direction
Z Third direction

1. A connection device comprising:
a flexible substrate;
a coaxial connector overlapping with the flexible substrate; and
a jig fixing the flexible substrate and the coaxial connector.

2. The connection device according to claim 1, wherein
at least a part of the jig is inserted through a communication hole communicating with the flexible substrate and the coaxial connector.

3. The connection device according to claim 1, further comprising
a rigid substrate located on a side of the flexible substrate opposite to a side on which the coaxial connector is located, wherein
the jig fixes the rigid substrate together with the flexible substrate and the coaxial connector.

4. The connection device according to claim 3, wherein
the flexible substrate includes a transmission line,
the rigid substrate is provided with a region at least partially overlapping with the transmission line, and
the region has a dielectric constant lower than a dielectric constant of the rigid substrate around the region.

5. The connection device according to claim 1, wherein
the flexible substrate includes a first conductor and a second conductor, and
at least a part of the coaxial connector is inserted through a hole provided in the second conductor, and electrically connected to the first conductor.

6. The connection device according to claim 5, further comprising
a third conductor located between the first conductor and the at least a part of the coaxial connector.

7. The connection device according to claim 1, further comprising
a spacer at least partially located inside the flexible substrate.

8. The connection device according to claim 7, wherein
the jig is inserted through the spacer.

9. The connection device according to claim 2, further comprising
a rigid substrate located on a side of the flexible substrate opposite to a side on which the coaxial connector is located, wherein
the jig fixes the rigid substrate together with the flexible substrate and the coaxial connector.

10. The connection device according to claim 9, wherein
the flexible substrate includes a transmission line,
the rigid substrate is provided with a region at least partially overlapping with the transmission line, and
the region has a dielectric constant lower than a dielectric constant of the rigid substrate around the region.

11. The connection device according to claim 2, wherein
the flexible substrate includes a first conductor and a second conductor, and
at least a part of the coaxial connector is inserted through a hole provided in the second conductor, and electrically connected to the first conductor.

12. The connection device according to claim 3, wherein
the flexible substrate includes a first conductor and a second conductor, and
at least a part of the coaxial connector is inserted through a hole provided in the second conductor, and electrically connected to the first conductor.

13. The connection device according to claim 4, wherein
the flexible substrate includes a first conductor and a second conductor, and
at least a part of the coaxial connector is inserted through a hole provided in the second conductor, and electrically connected to the first conductor.

14. The connection device according to claim 13, further comprising
a third conductor located between the first conductor and the at least a part of the coaxial connector.

15. The connection device according to claim 2, further comprising
a spacer at least partially located inside the flexible substrate.

16. The connection device according to claim 3, further comprising
a spacer at least partially located inside the flexible substrate.

17. The connection device according to claim 4, further comprising
a spacer at least partially located inside the flexible substrate.

18. The connection device according to claim 5, further comprising
a spacer at least partially located inside the flexible substrate.

19. The connection device according to claim 6, further comprising
a spacer at least partially located inside the flexible substrate.

20. The connection device according to claim 15, wherein
the jig is inserted through the spacer.
